(19) United States
(12) Patent Application Publication
(10) Pub. No.: US 2018/0219303 A1
(43) Pub. Date: Aug. 2, 2018

(54) TERMINAL CONNECTORS

(71) Applicant: Hubbell Incorporated, Shelton, CT (US)

(72) Inventors: Kevin Normand Castonguay, Weare, NH (US); Evan Ronald Martin, Merrimack, NH (US)

(21) Appl. No.: 15/423,338

(22) Filed: Feb. 2, 2017

(51) Int. Cl. H01R 4/24; H01R 43/16; H01R 4/18

(52) U.S. Cl. CPC H01R 4/2404; H01R 4/183; H01R 43/16

(57) ABSTRACT

A terminal connector for connecting to a conductor, the terminal connector including a conductor portion, a lug portion and a terminal insert extending into the conductor portion. The terminal insert receives the conductor. The terminal insert includes one or more inwardly extending coating piercing members. The one or more coating piercing members are capable of penetrating non-conductive coatings on the conductor.

### BACKGROUND

### Field

The present disclosure relates generally to connectors, and more particularly to terminal connectors.

### Description of the Related Art

Various types of connectors are used to connect conductors (e.g., wires, cables, etc.) to end point structures or other conductors. For example, connectors such as terminal connectors may include a proximal end having a barrel for receiving a terminal end of a conductor. Once the terminal end of the conductor is inserted into the barrel, the barrel is crimped to form a permanent connection. The distal end of the terminal connector may have different configurations depending on the desired application. For example, a ring terminal has a flat end having an orifice extending there through dimensioned to receive a screw, post, etc. The distal end may itself be a barrel, for example, in a butt or splice terminal used to connect two terminal ends of conductors together.

Conductors may be provided with one or more layers of non-conductive coating for protecting the conductor. For example, in some instances a conductor may have an insulating jacket layer such as, a THHN (Thermoplastic, High Heat resistant, Nylon) jacket insulation and a non-conductive coating, such as varnish, between the jacket and the conductor for preventing corrosion, oxidation, etc. In other instances, such as in transformer winding applications, a conductor may have only a non-conductive coating, such as varnish, for preventing corrosion, oxidation, etc. To ensure good electrical contact with the connector, the conductor's insulating jacket and non-conductive coating needs to be removed prior to inserting the conductor into the connector and crimping, thus requiring additional preparation time and effort. Removing the non-conductive coating may cause problems. For example, the non-conductive coating may be thin so that removing the coating is not easy. As a result, all or not enough of the non-conductive coating may be removed from the conductor. In addition, the conductor may be damaged while removing the non-conductive coating. Further, since the connector and the conductor may be made of dissimilar materials excessive removal of the non-conductive coating may result in galvanic corrosion between the dissimilar metals.

### SUMMARY

The present disclosure provides a terminal connector for connecting to a conductor. In one exemplary embodiment, the terminal connector includes a conductor portion, a lug portion and a terminal insert that can be inserted into the conductor portion. The terminal insert includes a central opening for receiving a conductor and one or more coating piercing members extending toward the central opening. The one or more coating piercing members are capable of penetrating non-conductive coatings on a conductor inserted into the terminal insert.

The present disclosure provides a method of forming a terminal connector. In one exemplary embodiment, the method comprises providing a substantially flat section of stock material, forming one or more coating piercing members on at least a portion of the substantially flat section of stock material, and rolling over the at least portion of the substantially flat section of stock material including the one or more coating piercing members to form a barrel.

The present disclosure also provides a terminal connector comprising a conductor portion, e.g., a barrel, including one or more coating piercing member formed on an interior surface of the conductor portion, the one or more coating piercing members are capable of penetrating a non-conductive coating on a conductor inserted into the terminal insert.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is an exploded perspective view of an exemplary embodiment of a ring terminal connector according to the present disclosure;

FIG. 2 is a perspective view of the ring terminal connector of FIG. 1 with a terminal insert inserted into a conductor portion of the ring terminal connector;

FIGS. 3A-3F are magnified views of a portion of the terminal insert of FIG. 1 depicting various exemplary embodiments of coating piercing members that extend into the terminal insert;

FIG. 4A is a perspective view of an exemplary embodiment of a terminal insert according to the present disclosure;

FIG. 4B is a perspective view of another exemplary embodiment of a terminal insert according to the present disclosure;

FIG. 5 is a perspective view of an exemplary embodiment of a splice terminal connector according to the present disclosure illustrating a terminal insert inserted into the splice terminal connector;

FIG. 6 is a perspective view of another exemplary embodiment of a splice terminal connector according to the present disclosure illustrating multiple terminal inserts inserted into the splice terminal connector;

FIG. 7 is a perspective view of an exemplary embodiment of a spade terminal connector according to the present disclosure illustrating a terminal insert inserted into a conductor portion of the spade terminal connector;

FIG. 8 is a perspective view of another exemplary embodiment of a ring terminal connector according to the present disclosure, illustrating the ring terminal connector being connected to a buss bar;

FIG. 9 is a perspective view of an exemplary embodiment of stock material used to make a ring terminal connector of FIG. 8 and illustrating coating piercing members along the conductor portion of the ring terminal connector;

FIG. 10 is an enlarged side view of a portion of the stock material of FIG. 9, illustrating the coating piercing members;

FIGS. 11-14 are perspective views of the stock material of FIG. 9 during various stages of the manufacturing process according to an exemplary methodology of the present disclosure;

FIG. 15 is a perspective view of another exemplary embodiment of a splice terminal connector according to the present disclosure;

FIG. 16 is a partial cutaway view of the splice terminal connector of FIG. 15 illustrating coating piercing members along an inner perimeter of the splice terminal connector;

FIG. 17 is a perspective view of another exemplary embodiment of a splice terminal connector according to the present disclosure; and

FIG. 18 is a partial cutaway view of the splice terminal connector of FIG. 17 illustrating coating piercing members extending longitudinally along an inner perimeter of the splice terminal connector.

### DETAILED DESCRIPTION

Terminal connectors according to the present disclosure are able to be used on conductors with no to little preparation to the conductor. The terminal connectors provide high electrical and mechanical performance. The various embodiments of the terminal connectors described herein may also be referred to as the “connectors.” The connectors according to the present disclosure may include one or more terminal inserts, e.g., barrel inserts, each having one or more coating piercing members extending inward. When the terminal connector is attached to a conductor, the coating piercing members penetrate through any non-conductive coatings and/or oxide on the conductor in the locations where there is direct contact between the coating piercing members and the conductor. Thus, materials that should not be in bare metal or uninsulated contact with one another due to the potential of galvanic corrosion could be used for the terminal insert and the conductor.

Exemplary embodiments of the present disclosure may be provided as improvements to terminal connectors. For example, a terminal connector may include a conductor portion and a lug portion such as a ring terminal. A terminal insert, including one or more inwardly extending coating piercing members, is inserted into the conductor portion. A conductor is inserted into the terminal insert and the conductor portion of the terminal connector is crimped so that the coating piercing members penetrate any nonconductive coating on the conductor.

Exemplary embodiments of the present disclosure may be provided as improvements to splice terminal connectors used to join conductors. For example, a splice terminal connector may include one or more terminal inserts, each including one or more inwardly extending coating piercing members. Conductors are inserted into the ends of the terminal insert and the splice terminal connector is crimped so that the coating piercing members penetrate any nonconductive coating on the conductors.

According to the various exemplary embodiments described herein, the terminal connectors and/or terminal inserts may be made of any suitable electrically conductive material including, for example brass, copper, copper alloy, aluminum, conductive steels such as stainless steel, etc. The terminal connectors and/or terminal inserts may be tin plated if desired. Further, the coating piercing members on the terminal inserts may be hardened, by for example heating, as is known for added hardness to penetrate the non-conductive coating on the conductor and/or to facilitate ease in manufacturing the terminal inserts.

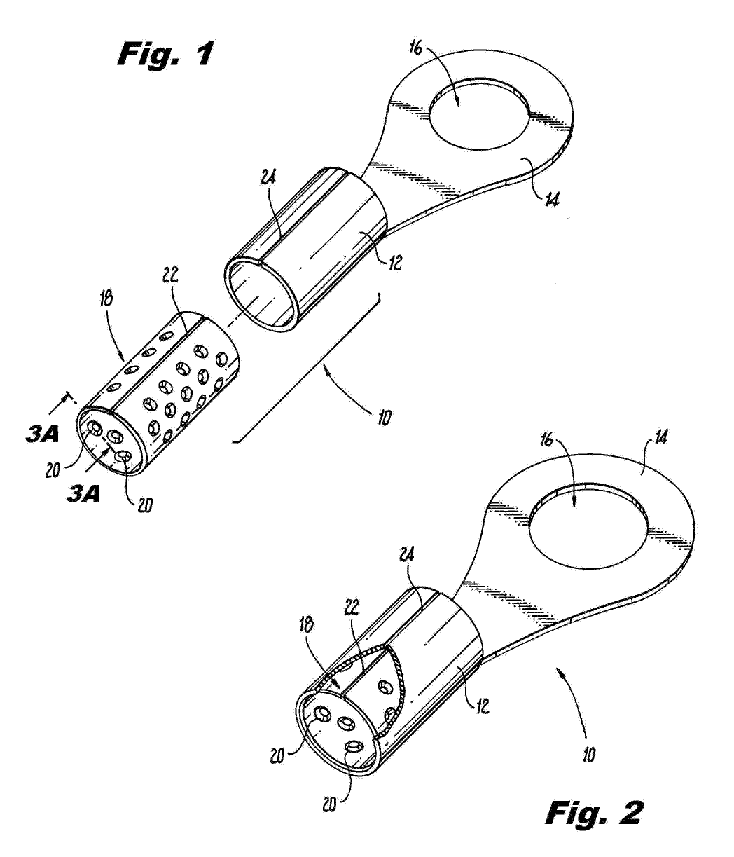

A terminal connector according to an exemplary embodiment of the present disclosure is shown in FIGS. 1 and 2, and is referred to generally as connector 10. Connector 10 includes a conductor portion 12, a lug portion 14 and a terminal insert 18. Conductor portion 12 may have various configurations, depending on a particular application. For example, according to the present illustrative embodiment, the conductor portion 12 may be cylindrical, barrel or tubular in shape. However, the conductor portion 12 may have other shapes such as a pentagon shape or hexagon shape. Lug portion 14 may have various configurations, depending on a particular application. For example, according to the present illustrative embodiment, connector 10 is a ring terminal and lug portion 14 is generally flat and includes an orifice 16 extending there through. Depending on a particular application, lug portion 14 may be a male or female spade connector, blade connector, bullet connector, etc. The terminal insert 18 may have various configurations, depending on a particular application. For example, according to the present illustrative embodiment, the terminal insert 18 may be cylindrical, barrel or tubular in shape having a central opening that can receive a conductor. However, the terminal insert 18 may have other shapes such as a pentagon shape or hexagon shape having a central opening that can receive a conductor. Typically, the terminal insert 18 is configured to fit within the conductor portion 12 of the connector 10. The terminal insert 18 includes one or more coating penetrating members that extend inwardly into the central opening of the terminal insert. In the embodiment shown, the terminal insert 18 includes a plurality of spaced coating piercing members 20 that extend inward into the central opening of the terminal insert 18. Terminal insert 18 and/or conductor portion 12 may include a slot 22 or 24 extending the length thereof, respectively, the purpose of which will be described later below.

Connector 10 is attached to a conductor, such as a wire or cable (not shown), by inserting the conductor into terminal insert 18 and crimping conductor portion 12. Crimping conductor portion 12 transfers force to the terminal insert 18 such that the spaced coating piercing members 20 penetrate any non-conductive coating on the conductor and contact the bare metal of the conductor creating an electrically conductive path between the connector 10 and the conductor. More specifically, once crimped, the spaced coating piercing members 20 pierce through the non-conductive coating allowing current to flow through the terminal insert 18, the conductor portion 12 and the lug portion 14. Since the non-conductive coating remains on the portions of the conductor that is not in contact with the coating piercing members 20, dissimilar metals can be used for the conductor and the terminal insert 18. That is, the remaining non-conductive coating limits and possibly prevents galvanic corrosion from occurring between the dissimilar metals.

According to an exemplary embodiment of the present disclosure, during manufacture of connector 10 the terminal insert 18 is inserted into conductor portion 12 and secured to the conductor portion. The terminal insert 18 may be press fit into the conductor portion 12, spring fit into the conductor portion or secured to the conductor portion with an adhesive or by welds or solder. Slot 22 in terminal insert 18 allows terminal insert 18 to be compressed slightly and slot 24 in conductor portion 12 allows conductor portion to expand slightly, thus allowing terminal insert 18 to be spring fit into conductor portion. The entire connector 10 may then be tin plated to further secure the terminal insert 18 to the conductor portion 12. According to another exemplary embodiment, terminal insert 18 may be sold as a separate unit from the connector 10. An end user can insert the conductor into the terminal insert 18 just prior to inserting the terminal insert 18 into conductor portion 12. The conductor portion 12 can then be crimped to secure a conductor to the connector 10.

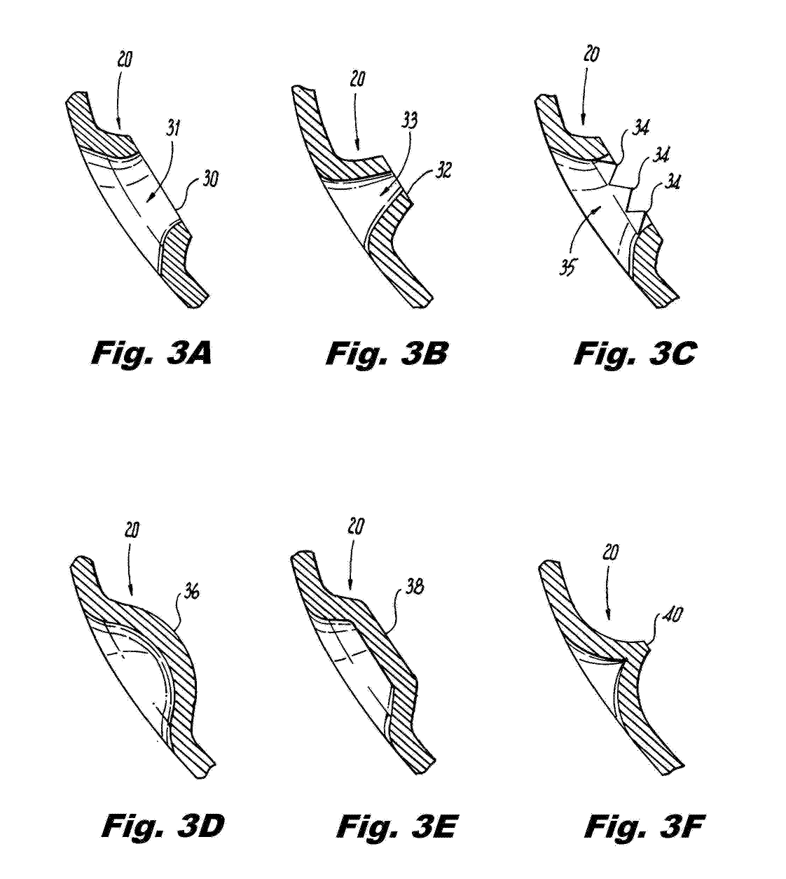

The shape of the coating piercing members 20 may vary. For example, according to the exemplary embodiment shown in FIG. 3A, the coating piercing members 20 may have flat distal ends 30. According to another exemplary embodiment, as shown in FIG. 3B, the spaced coating piercing members 20 may have pointed distal ends 32. According to another exemplary embodiment, as shown in FIG. 3C, the spaced coating piercing members 20 may have serrated distal ends 34. According to the exemplary embodiments shown in FIGS. 3A-3C, an orifice (31, 33, 35) extends at least partially through each spaced coating piercing member. As shown in FIGS. 3D-3F, other exemplary embodiments of the coating piercing members do not include an orifice. For example, according to the exemplary embodiment shown in FIG. 3D, the coating piercing members 20 may have a rounded bump shape. According to the exemplary embodiment shown in FIG. 3E, the coating piercing members 20 may have a closed flat end 38. According to the exemplary embodiment as shown in FIG. 3F, the coating piercing members 20 may have closed pointed ends 40. Of course, the spaced coating piercing members may take shapes other than those depicted in FIGS. 3A-3F.

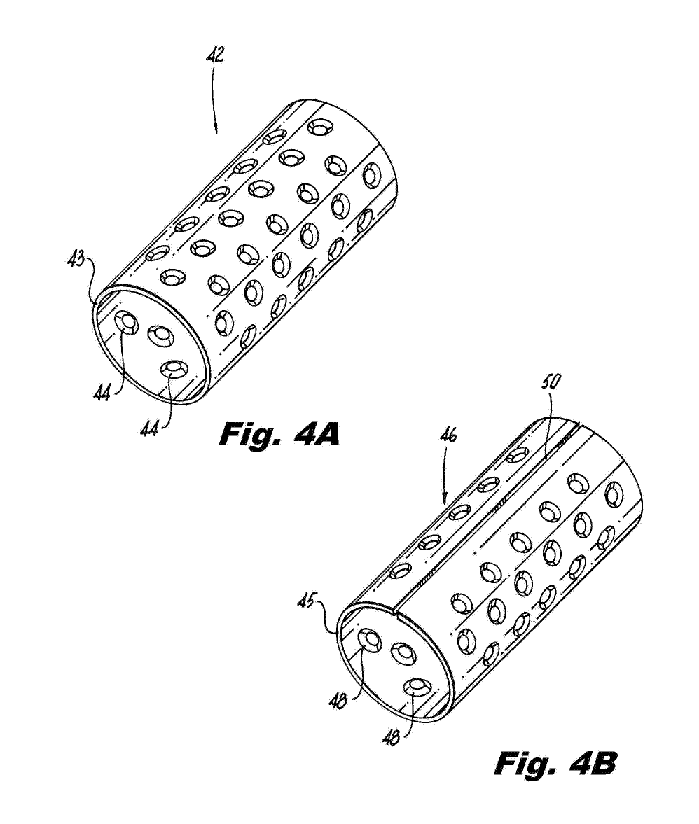

FIGS. 4A and 4B are enlarged views of terminal inserts according to exemplary embodiments of the present disclosure. The terminal insert 42 shown in FIG. 4A is a solid tube or barrel 43 having central opening that can receive a conductor and spaced coating piercing members 44 which extend inward toward the central opening of the tube 43. The terminal insert 46 shown in FIG. 4B is a tube or barrel 45 having a slit 50 extending the length thereof. Spaced coating piercing members 48 extend inward toward the central opening of the tube 45. Terminal insert 42 (FIG. 4A) is suitable for being press fit into a conductor portion of a connector and being secured with a friction fit, an adhesive or by welds or solder. Terminal insert 46 is suitable for being spring fit and/or press fit into a conductor portion of a connector and may be secured with a friction fit, an adhesive or by welds or solder. The coating piercing members 44 and 48 may be distributed along the terminal insert 42 and 46 respectively in various configurations or patterns. For example, the coating piercing members (44 and 48) may be arranged in the pattern as shown in FIGS. 4A and 4B. However, it will be appreciated that the spaced coating piercing members may be arranged randomly or in patterns other than that shown.

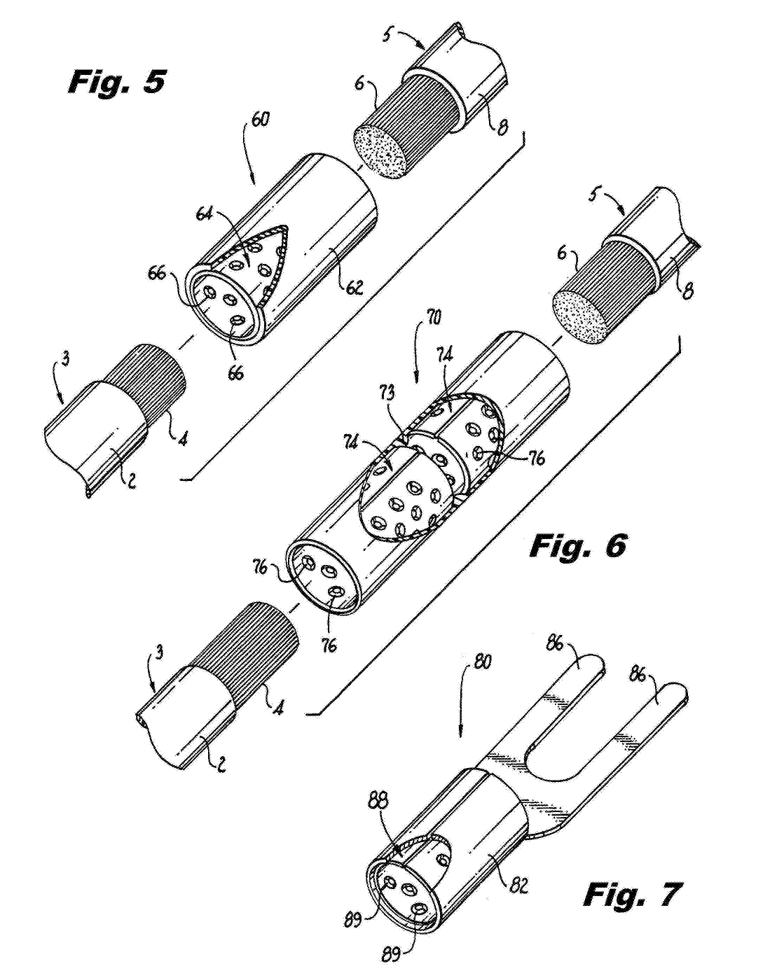

A terminal connector according to another exemplary embodiment of the present disclosure as shown in FIG. 5 and is referred to generally as splice terminal connector 60 or connector 60. Connector 60 is utilized to connect one conductor to another conductor. The connector 60 may be circular, barrel or tubular in shape, or may have other shapes such as a pentagon shape or a hexagon shape. The connector 60 shown includes a solid tube or sleeve 62 and a terminal insert 64. The terminal insert 64 is press fit or spring fit into sleeve 62. Terminal insert 64 may be secured within sleeve 62 with a friction fit, an adhesive or by welds or solder. The entire connector 60 may be tin plated to further secure the terminal insert 64 to the sleeve 62. Terminal insert 64 includes a central opening that can receive a conductor and one or more coating piercing members 66 which extend inward toward the central opening of the terminal insert 64. The coating piercing members 66 may have one or more of the configurations shown in FIGS. 3A-3F.

To connect conductors to the connector 60, conductors 3 and 5 are prepared by stripping a portion of insulating jackets 2 and 8, respectively, as shown, to uncover the distal ends of conductors 4 and 6, which may have a non-conductive coating, such as for example varnish or the like. The distal ends of conductors 4 and 6 are inserted through the ends of terminal insert 62, as shown, and crimped. Crimping causes the spaced coating piercing members 66 to pierce any non-conductive coating on conductors 4 and 6 to create an electrically conductive path between the conductor and the connector 60. It is noted that the conductors may be stranded conductors as shown or the conductors may be solid conductors.

Referring to FIG. 6, a terminal connector according to another exemplary embodiment of the present disclosure is shown and is referred to generally as splice terminal connector 70 or connector 70. Connector 70 is also utilized to connect one conductor to another conductor. The connector 70 may be circular, barrel or tubular in shape, or may have other shapes such as a pentagon shape or a hexagon shape. The connector 70 shown includes a solid tube or sleeve 72 and multiple terminal inserts 74. A raised surface 73 extends around at least a portion of the inner circumference of sleeve 72. The raised surface 73 acts as a stop for preventing the conductor and/or terminal insert from being inserted too far into sleeve 72. The terminal insert 74 is press fit or spring fit into each end of sleeve 72 until they contact raised surface 73. Terminal inserts 74 may be secured within sleeve 72 with a friction fit, an adhesive or by welds or solder. The entire connector 70 may be tin plated to further secure the terminal insert to the sleeve 72. Each terminal insert 74 includes a central opening that can receive a conductor and one or more coating piercing members 76 which extend inward toward the central opening of the terminal inserts 74. The coating piercing members 76 may have for example one or more of the configurations shown in FIGS. 3A-3F.

To connect conductors to the connector 70, conductors 3 and 5 are prepared by stripping a portion of insulating jackets 2 and 8, respectively, as shown, to uncover the distal ends of conductors 4 and 6. The distal ends of the conductors 4 and 6 are inserted through the ends of terminal inserts 74 and crimped. Crimping causes the spaced coating piercing members 76 to pierce any non-conductive coating on conductors 4 and 6 to create an electrically conductive path between the conductor and the connector 70. It is noted that the conductors may be stranded conductors as shown or the conductors may be solid conductors.

Terminal inserts according to the present disclosure may be provided in virtually any type of connector desired. For example, according to another exemplary embodiment, a terminal insert is provided in a spade terminal connector shown in FIG. 7 and referred to as spade terminal connector 80 or connector 80. Connector 80 includes a conductor portion 82, a lug portion 84 and a terminal insert 88. The conductor portion 82 is similar to the conductor portion 22 described above and for ease of description is not repeated. The lug portion 84 may have various configurations, depending on a particular application. For example, according to the present illustrative embodiment, connector 80 is a spade terminal connector and lug portion 84 is generally flat and includes a pair of flat prongs 86 extending therefrom. The terminal insert 88 may have various configurations, depending on a particular application. For example, according to the present illustrative embodiment, the terminal insert 88 may be cylindrical, barrel or tubular in shape. However, the terminal insert 88 may have other shapes such as a pentagon shape or hexagon shape. Typically, the terminal insert 88 is configured to fit within the conductor portion 82 of the connector 80. For example, the terminal insert 88 may be press fit or spring fit into conductor end 82. The terminal insert 88 includes a central opening that can receive a conductor and one or more coating piercing members 89 which extend inward toward the central opening of the terminal insert. The coating piercing members 89 may have for example one or more of the configurations shown in FIGS. 3A-3F and may be spaced in various patterns or arrangements as described herein. Terminal insert 88 may be secured within conductor end 82 with a friction fit, an adhesive or by welds or solder. The entire connector 80 may be tin plated to further secure the terminal insert 88 to the conductor portion 82.

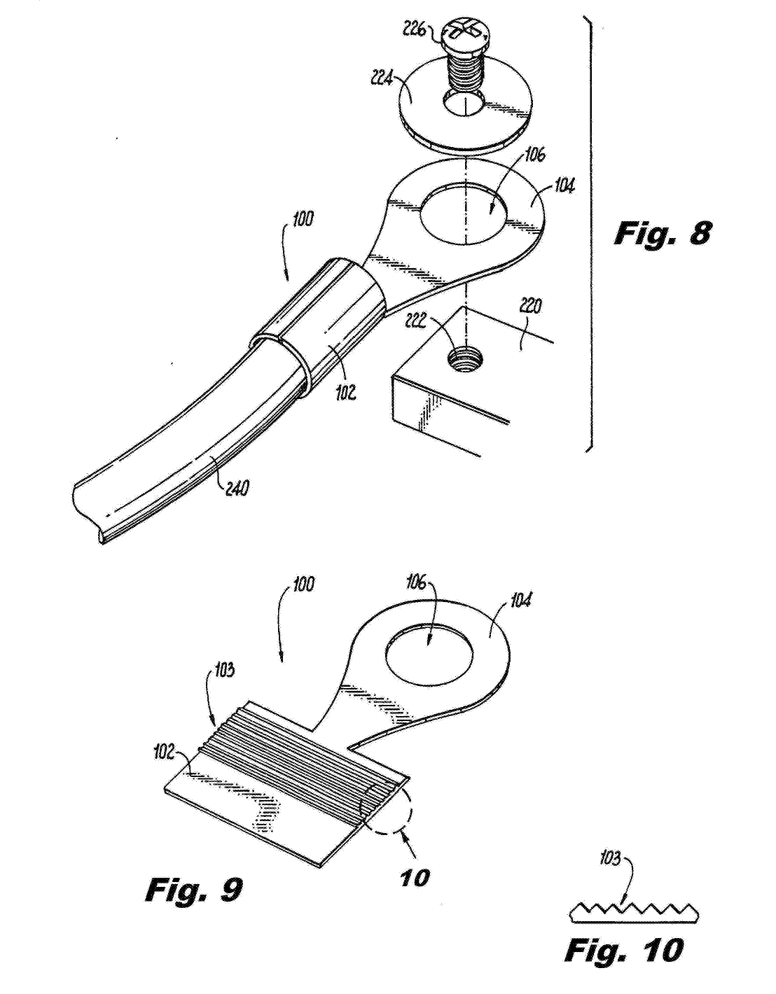

Another terminal connector according to an exemplary embodiment of the present disclosure is shown in FIG. 8 and is referred to as connector 100. Connector 100 includes a conductor portion 102 and a lug portion 104 having an orifice 106 provided therein. As will be described later below, the internal surface of conductor portion 102 includes thread-like coating piercing members so that connector 100 can be rotated and threaded onto conductor 240. The thread-like coating piercing members penetrate any non-conductive coatings on the conductor. Conductor portion 102 may be crimped if desired. In the exemplary embodiment shown, the connector 100 is a ring connector and is capable of being mounted to a structure, such as buss bar 220, having a threaded orifice 222 and utilizing a washer 224 and bolt 226.

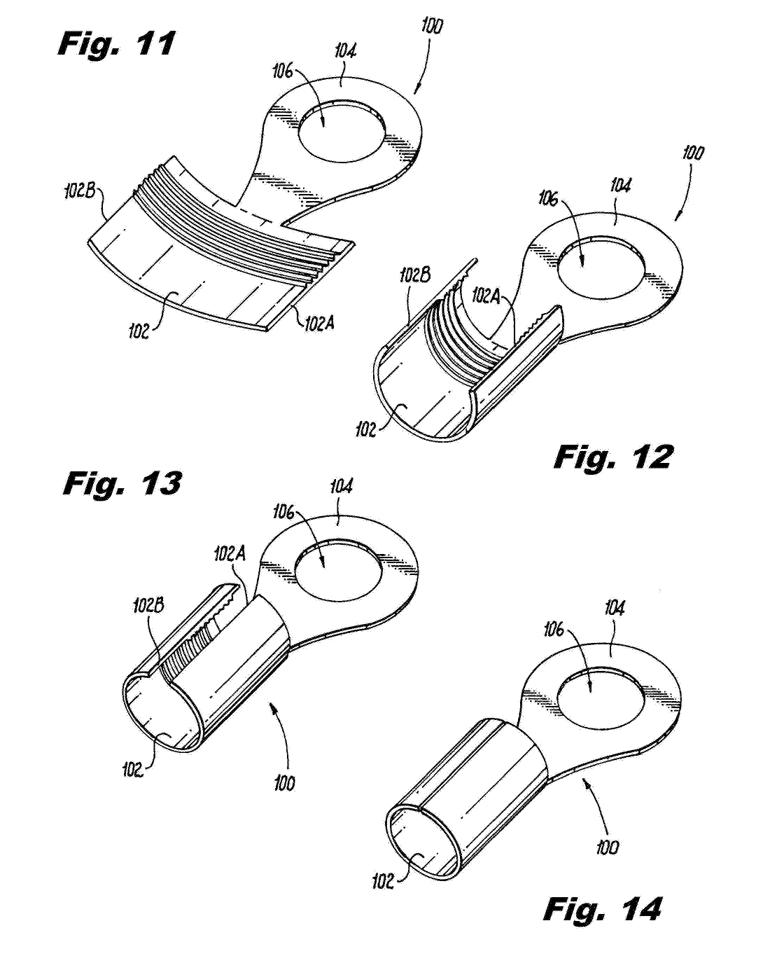

Connector 100 may be punched or cut from a section of stock material as shown in FIG. 9. For example, the connector 100 may be made from an electrically conductive material such as brass, copper, copper alloy, aluminum, conductive steels such as stainless steel, etc. Connector 100 includes a substantially rectangular conductor portion 102 and circular lug portion 104 having an orifice 106 extending there through. One or more coating piercing members 103 are etched, cut or otherwise formed in a least a portion of rectangular conductor portion 102. As shown in FIG. 10, in this exemplary embodiment, the one or more coating piercing members 103 form a series of rows of triangular teeth. Referring now to FIGS. 11-14, the edges 102A, 102B of rectangular conductor portion 102 are rounded over until the edges substantially touch as shown in FIG. 14. At this point, the one or more coating piercing members 103 form a series of threads on the inside of conductor portion 102.

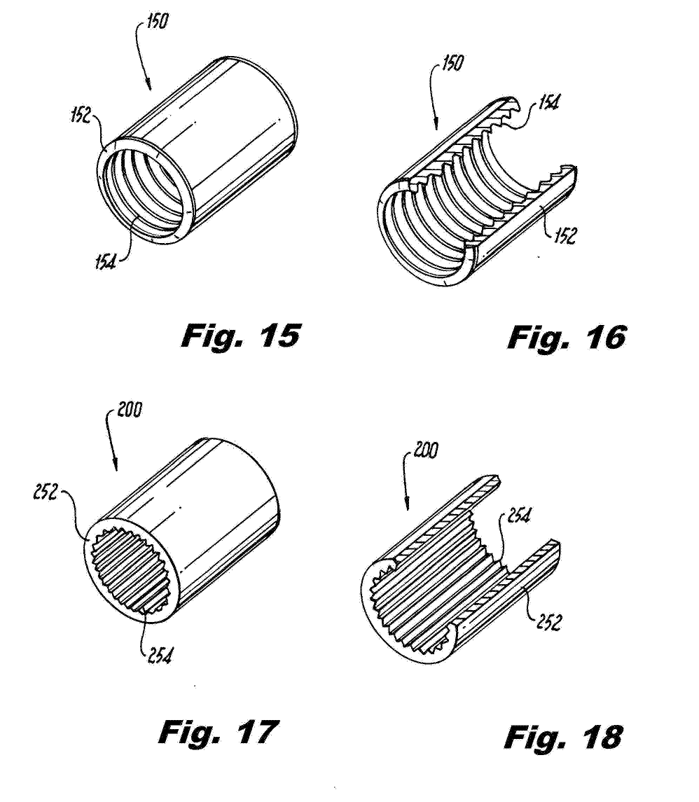

A terminal connector according to another exemplary embodiment is shown in FIGS. 15 and 16 and is referred to generally as connector 150. Connector 150 can be circular, barrel or tubular in shape, or the connector 150 can have other shapes such as a pentagon shape or a hexagon shape. In the embodiment shown, the connector 150 is generally a tube 152 having one or more thread-like spaced coating piercing members 154 on the interior surface. The thread-like spaced coating piercing members 154 may be formed using a tap. Connector 150 may be made from an electrically conductive material such a brass, copper, copper alloy, aluminum, conductive steels such as stainless steel, etc. Connector 150 is attached to a conductor by crimping the connector so that the thread-like coating piercing members penetrate any non-conductive coatings on the conductor. In another embodiment, the connector 150 is attached to a conductor by rotating the connector and threading it onto the conductor in a manner similar to that described above with the respect to the embodiment depicted in FIGS. 8-14. The thread-like coating piercing members penetrate any non-conductive coatings on the conductor. Although depicted as a splice connector, it will be appreciated that an end of connector 150 may have shapes other than that shown. For example, an end of connector 150 may be a lug portion similar to those described above, including, for example, a ring terminal, a male or female spade connector, blade connector, bullet connector, etc.

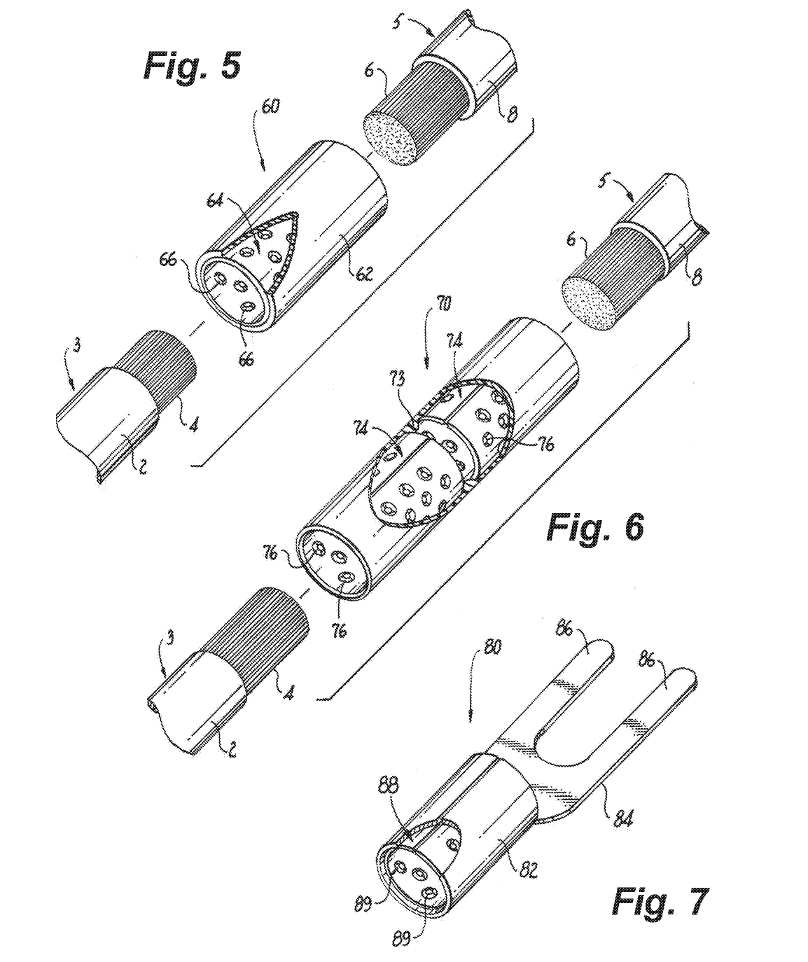

A terminal connector according to another exemplary embodiment is shown in FIGS. 17 and 18 and is referred to generally as connector 200. Connector 200 can be circular, barrel or tubular in shape, or the connector 200 can have other shapes such as a pentagon shape or a hexagon shape. In the embodiment shown, the connector 200 is generally a tube 252 having one or more spaced coating piercing members 254 on the interior surface of the tube 252 extending along the length of the tube or parallel to the longitudinal axis of the tube. Connector 200 may be made from an electrically conductive material such a brass, copper, copper alloy, aluminum, conductive steels such as stainless steel, etc. The connector 200 may be made through an extrusion process where the electrically conductive material is forced to flow through a shaped opening in a die (not shown) that includes a shape to form the spaced coating piercing members 254. The extruded metal material emerges as an elongated piece with the same profile as the die opening and is then cut to length. Connector 200 is attached to a conductor by crimping the connector so that the coating piercing members 254 penetrate any non-conductive coatings on the conductor. Although depicted as a splice connector, it will be appreciated that an end of connector 200 may have shapes other than that shown. For example, an end of connector 200 may be a lug portion similar to those described above, including, for example, a ring terminal, a male or female spade connector, blade connector, bullet connector, etc.

The illustrative embodiments of the present disclosure provide salient benefits, including enhanced electrical and mechanical performance. For example, the spaced coating piercing members provide increased tensile strength against conductor pullout. In addition, the spaced coating piercing members penetrate any non-conductive coating (e.g., varnish) on the conductor and allow current to pass in these areas. However, the non-conductive coating remains intact on other portions of the conductor. Accordingly, dissimilar metals can be used for the conductor and the terminal insert, since the remaining non-conductive coating will prevent galvanic corrosion from occurring between the dissimilar metals.

While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

1. A terminal connector comprising:
a conductor portion;
a lug portion;
a terminal insert positioned within the conductor portion, the terminal insert including a central opening for receiving a conductor; and
at least one coating piercing member having a circular raised surface that extends toward the central opening such that the circular raised surface forms an aperture in the at least one coating piercing member.

2. The terminal connector as recited in claim 1, wherein the lug portion comprises at least one of a ring connector, a male spade connector, a female spade connector, a blade connector and a bullet connector.

3. The terminal connector as recited in claim 1, further comprising: a second conductor portion, wherein a second terminal insert is positioned within the second conductor portion, the second terminal insert including a central opening for receiving a second conductor and at least one coating piercing member extending toward the central opening, and wherein the at least one coating piercing member is capable of penetrating a non-conductive coating on the received second conductor.

4. The terminal connector as recited in claim 3, wherein the at least one coating piercing member on the second terminal insert has at least one of a flat distal end, a pointed distal end and a serrated distal end.

5. The terminal connector as recited in claim 4, wherein an orifice extends through the flat distal end, the pointed distal end and the serrated distal end.

6. The terminal connector as recited in claim 3, wherein the at least one coating piercing member on the second terminal insert has at least one of a rounded bump, a closed flat end and a closed pointed end.

7. The terminal connector as recited in claim 1, wherein the terminal connector is made of an electrically conductive material.

8. The terminal connector as recited in claim 7, wherein the electrically conductive material comprises at least one of brass, copper, copper alloy, tin, conductive steel and stainless steel.

9. The terminal connector as recited in claim 1, wherein the at least one coating piercing member on the terminal insert has at least one of a flat distal end, a pointed distal end and a serrated distal end.

10. The terminal connector as recited in claim 9, wherein an orifice extends through the flat distal end, the pointed distal end and the serrated distal end.

11. The terminal connector as recited in claim 1, wherein the at least one coating piercing member on the terminal insert has at least one of a rounded bump, a closed flat end and a closed pointed end.

12. A method of forming a terminal connector comprising:
providing a substantially flat section of stock material that is connected to a lug portion;
forming at least one coating piercing member on at least a portion of the substantially flat section of stock material; and
rolling over the at least portion of the substantially flat section of stock material including the at least one coating piercing member to form a barrel, such that each end of the barrel includes a central opening, wherein the at least one end of the barrel is connected to the lug portion.

13. The method as recited in claim 12, wherein the at least one coating piercing member is provided in an inside of the barrel.

14. The method as recited in claim 12, wherein the at least one coating piercing member is a thread on the inside of the barrel

15. The method as recited in claim 12, wherein the at least one coating piercing member is capable of penetrating a non-conductive coating on a conductor within the barrel.

16. The method as recited in claim 12, wherein the substantially flat section of material comprises an electrically conductive material.

17. The method as recited in claim 16, wherein the electrically conductive material comprises at least one of brass, copper, copper alloy, conductive steel and stainless steel.

18. A terminal connector comprising:
a lug portion;
a conductor portion formed into a barrel having a central opening at each end such that at least one end of the barrel is connected to the lug portion; and
at least one coating piercing member formed on an interior surface of the conductor portion, the at least one coating piercing member being capable of penetrating a non-conductive coating on a conductor.

19. The terminal connector as recited in claim 18, further comprising a lug portion.

20. The terminal connector as recited in claim 19, wherein the lug portion comprises at least one of a ring connector, a male spade connector, a female spade connector, a blade connector, a second conductor portion and a bullet connector.

21. The terminal connector as recited in claim 18, wherein the at least one coating piercing member comprises a raised thread.

22. The terminal connector as recited in claim 18, wherein the conductor portion comprises an electrically conductive material.

23. The terminal connector as recited in claim 22, wherein the electrically conductive material comprises at least one of brass, copper, copper alloy, tin, conductive steel and stainless steel.
